(19) United States
(12) Patent Application Publication
(10) Pub. No.: US 2015/0144377 A1
(43) Pub. Date: May 28, 2015

(54) REDUCED DELAY DATA CABLE

(71) Applicant: General Cable Technologies Corporation, Highland Heights, KY (US)

(72) Inventor: David M. FAUSZ, Fort Thomas, KY (US)

(21) Appl. No.: 14/546,526

(22) Filed: Nov. 18, 2014

Related U.S. Application Data
(60) Provisional application No. 61/909,119, filed on Nov. 26, 2013.

(51) Int. Cl. H01B 11/04; H01B 3/30; H01B 13/32

(52) U.S. Cl. CPC H01B 11/04; H01B 13/329; H01B 3/30
USPC 174/116

(57) ABSTRACT

A data cable includes a core and a jacket surrounding the core. The core defines a longitudinal axis and includes a central twisted pair of insulated conductors and a plurality of outer twisted pairs of insulated conductors. The central twisted pair of insulated conductors is disposed along the longitudinal axis and has a lay length. Each outer twisted pair of the plurality of outer twisted pairs has a lay length.

### REFERENCE TO RELATED APPLICATION

The present application claims priority of U.S. provisional application Ser. No. 61/909,119, entitled REDUCED DELAY DATA CABLE, filed Nov. 26, 2013, and hereby incorporates the same application herein by reference in its entirety.

### TECHNICAL FIELD

This disclosure generally relates to a cable having a plurality of twisted pairs of conductors. At least two of the twisted pairs have different lay lengths.

### BACKGROUND

Conventional data cables typically include twisted pairs of insulated conductors that are surrounded by an outer protective jacket. Twisting the pairs of conductors can alleviate crosstalk—signal interference among adjacent parallel conductors. The twisting of the conductor pairs is measured in terms of lay length—the longitudinal length along which one full twist of the conductors occurs. The lay length of a twisted pair can affect crosstalk and the signal propagation speed within the twisted pair. A twisted pair having a shorter lay length can be less susceptible to crosstalk but can experience slower signal propagation speeds than twisted pairs having a longer lay length.

As data speeds increase, twisting of the conductors into pairs has become less effective at inhibiting crosstalk, including alien crosstalk among adjacent cables. Some conventional arrangements include a shielding element, such as an aluminum tape, to alleviate alien crosstalk. However, such shielding elements require grounding and can add significant cost and weight to the cable. In some conventional arrangements the shielding element can be discontinuous to eliminate the need for grounding. However, discontinuous shielding elements can provide gaps in the shielding coverage which cause the cable to be susceptible to alien crosstalk, including Power Sum Alien Near-End (PSANEXT) Crosstalk and Power Sum Attenuation-to-Alien Crosstalk Ratio, Far-End (PSAACRF) Crosstalk.

Some conventional cable arrangements include a centrally located twisted conductor pair with other twisted pairs that surround the centrally located twisted pair. The centrally located twisted pair has a longer lay length than the other twisted pairs. The centrally located twisted pairs can accordingly have the fastest signal of all of the pairs in the cable. The other twisted pairs can be susceptible to poor signal propagation speed (e.g., due to helical loss) and high delay skew which can prevent the data cable from meeting industry standards, such as TIA 568, for example. The TIA 568 standard relates to the electrical properties of data cable and particularly delay issues. Since conductor pairs of a cable are typically twisted at different lengths, signals will arrive at the end of the cable at different times. The TIA 568 standard calls for a maximum delay skew of 45 nS. That is, once the first signal is received on one conductor pair, the last signal on a different conductor pair has 45 nS to arrive.

Providing a centrally located twisted pair having a longer lay length than other twisted pairs can adversely affect the ability of the cable to meet the TIA 568 standard, to meet the requirements for reduced internal cable crosstalk (NEXT), and to appropriately inhibit alien crosstalk. For example, although the other twisted pairs have shorter lay lengths than the center pair, those lay lengths typically are not short enough to effectively reduce alien crosstalk because the difference in the lay length of the center pair with the longest lay length and the lay lengths of the three pairs around the center pair is limited by the maximum delay skew allowed of the pair signals.

### SUMMARY

In accordance with one embodiment, a data cable comprises a core and a jacket surrounding the core. The core defines a longitudinal axis and comprises a central twisted pair of insulated conductors and a plurality of outer twisted pairs of insulated conductors. The central twisted pair of insulated conductors is disposed along the longitudinal axis and has a lay length. Each outer twisted pair of the plurality of outer twisted pairs has a lay length. Each outer twisted pair is positioned relative to the central twisted pair such that each outer twisted pair of the plurality of outer twisted pairs is disposed between the central twisted pair and the jacket. The lay length of the central twisted pair is shorter than the respective lay lengths of each outer twisted pair of the plurality of outer twisted pairs.

In accordance with another embodiment, an unshielded data cable comprises a core and a jacket surrounding the core. The core defines a longitudinal axis and comprises a central twisted pair of insulated conductors, a first outer twisted pair of insulated conductors, a second outer twisted pair of insulated conductors, and a third outer twisted pair of insulated conductors. The central twisted pair of insulated conductors is disposed along the longitudinal axis and has a central lay length. The first outer twisted pair has a first lay length. The second outer twisted pair has a second lay length. The third outer twisted pair has a third lay length. The first, second, and third outer twisted pairs are positioned relative to the central twisted pair such that the first, second, and third outer twisted pairs are disposed between the central twisted pair and the jacket. The central lay length of the central twisted pair is less than the first, second, and third lay lengths of the respective first, second, and third outer twisted pairs. The first, second, and third, lay lengths are different.

In accordance with one embodiment, a data cable comprises a core and a jacket surrounding the core. The core defines a longitudinal axis and comprises a central twisted pair of insulated conductors, a first outer twisted pair of insulated conductors, a second outer twisted pair of insulated conductors, and a third outer twisted pair of insulated conductors. The central twisted pair of insulated conductors is disposed along the longitudinal axis and has a central lay length. The first outer twisted pair has a first lay length. The second outer twisted pair has a second lay length. The third outer twisted pair has a third lay length. Each conductor of the central twisted pair of insulated conductors comprises an insulating layer. Each conductor of the plurality of outer twisted pairs comprises an insulating layer. The insulating layers of the conductors of the central twisted pair are formed of a fluoropolymer. The insulating layers of the conductors of the first, second, and third outer twisted pairs are formed of a non-fluoropolymer material.

### BRIEF DESCRIPTION OF THE DRAWINGS

It is believed that certain embodiments will be better understood from the following description taken in conjunction with the accompanying drawings in which:

FIG. 1 is a cross-sectional view of a data cable, according to one embodiment;

FIG. 2 is a cross-sectional view of a data cable, according to another embodiment;

FIG. 3 is a cross-sectional view of a data cable, according to yet another embodiment;

FIG. 4 is a cross-sectional view of a data cable, according to still another embodiment; and

FIG. 5 is a cross-sectional view of a data cable, according to still another embodiment.

### DETAILED DESCRIPTION

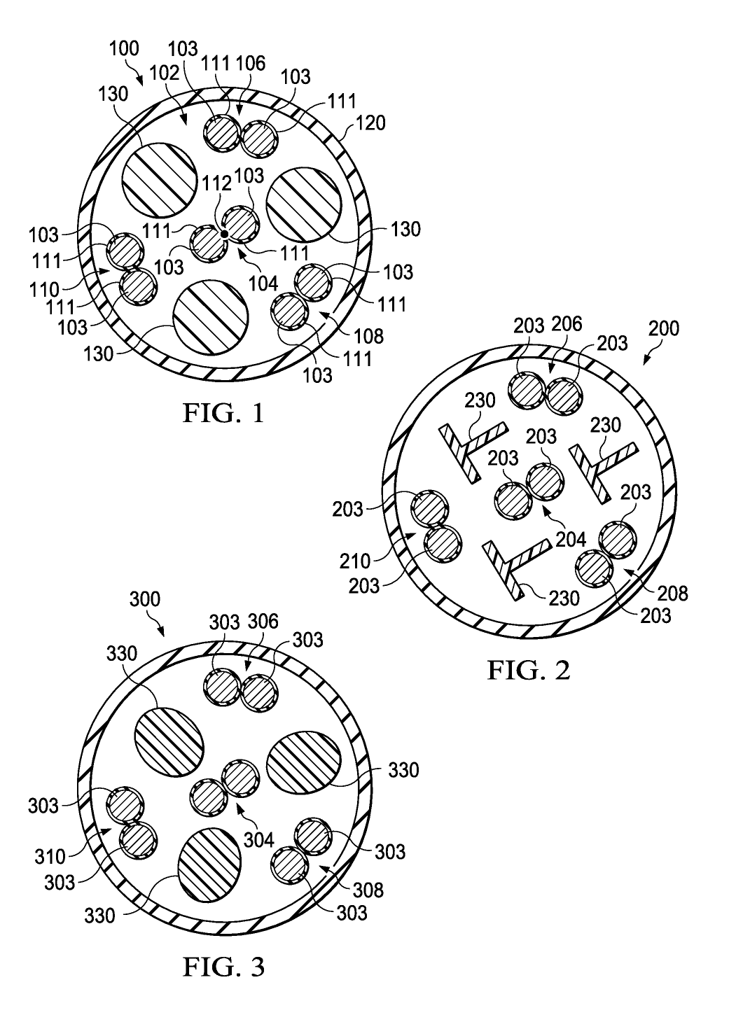

In connection with the views and examples of FIGS. 1-5, wherein like numbers indicate the same or corresponding elements throughout the views, FIG. 1 illustrates a data cable 100 that can include a core 102 having a plurality of conductors 103 that are arranged into a central twisted pair 104 and a plurality of outer twisted pairs 106, 108, 110. Twisting of the conductors 103 into pairs can encourage signal propagation along the conductors while discouraging crosstalk, including alien crosstalk. The data cable 100 can also include an outer jacket 120 that surrounds the core 102. Each of the conductors 103 can include an insulating layer 111 which can be formed of any of a variety of insulating materials, such as, for example, fluorinated ethylene propylene (FEP), tetrafluoroethylene perfluoromethyl vinyl ether copolymer (MFA), high density polyethylene (HDPE), flame retardant polyolefin, and the like. The outer jacket 120 can be formed of any of a variety of materials such as polyvinyl chloride (PVC), FEP, flame retardant polyolefin and the like. In one embodiment, the data cable 100 can be devoid of any shielding (e.g., unshielded) and thus lighter and more cost effective than some conventional shielded cables.

Still referring to FIG. 1, the data cable 100 can define a longitudinal axis 112 (e.g., a centerline). The central twisted pair 104 can be disposed along the longitudinal axis 112 such that the central twisted pair 104 is generally routed along a center of the data cable 100 (e.g., with the conductors 103 of the central twisted pair 104 twisted around the longitudinal axis 112). Each of the outer twisted pairs 106, 108, 110 can generally be positioned relative to (e.g., surround) the central twisted pair 104, as illustrated in FIG. 1, such that each outer twisted pair 106, 108, 110 is disposed between the central twisted pair 104 and the outer jacket 120 and offset from the longitudinal axis.

Each of the twisted pairs 104, 106, 108, 110 can have a respective lay length. The lay length of the central twisted pair 104 can be shorter than the respective lay lengths of each of the outer twisted pairs 106, 108, 110 (e.g., the central twisted pair 104 can be twisted tighter than the outer twisted pairs 106, 108, 110). In one embodiment, the lay lengths of the outer twisted pairs 106, 108, 110 can be different from one another. In one embodiment, the longest lay length among the outer twisted pairs 106, 108, 110 can be between about 7.75 mm and about 9.14 mm. In another embodiment, the lay length of the central twisted pair 104 can be between about 6.35 mm and about 7.75 mm. In another embodiment, the maximum difference in lay length between the central twisted pair 104 and the longest lay length among the outer twisted pairs 106, 108, 110 is about 2.8 mm.

Positioning the central twisted pair 104 between the outer twisted pairs 106, 108, 110 can overcome some of the shortcomings associated with short lay lengths. For example, the central twisted pair 104 may not be as susceptible to alien crosstalk, helical loss and signal propagation delay since it is not stranded around the other pairs in the data cable as in conventional arrangements. As such, the central twisted pair 104 can have a shorter lay length than conventional cable arrangements, which in turn can allow for the lay lengths of the outer twisted pairs 106, 108 and 110 to be reduced (e.g., relative to conventional arrangements) which can provide improved alien crosstalk performance and a delay skew that meets various industry standards, such as the TIA 568 standard. It is to be appreciated that, although the central twisted pair 104 is shown to be surrounded by three outer twisted pairs 106, 108, 110, any suitable quantity of outer twisted pairs can be provided.

In one embodiment, the insulating layer 111 of the central twisted pair 104 can be selected to encourage fast signal propagation speeds along the central twisted pair 104. For example, the insulating layer 111 can be formed of a fluoropolymer, such as FEP, a polyolefin, or any of a variety of suitable alternative materials or combination thereof that provide a suitable dielectric constant and/or insulating characteristic for inhibiting signal loss in the central twisted pair 104. In one embodiment, only the insulating layer 111 of the central twisted pair 104 can be formed of an FEP material, while the insulating layers 111 of the outer twisted pairs 106, 108, 110 can be formed of a non-FEP material. In some embodiments, the insulating layers 111 can either be formed of a solid or foamed material. For example, in one embodiment, the insulating layer 111 of the central twisted pair 104 can be formed of a foamed material and the insulating layers 111 of the outer twisted pairs 106, 108, 110 can be formed of a solid material. It is to be appreciated that foamed material can provide better insulating characteristics relative to a solid material due to the air voids imparted to the foamed material during installation.

Still referring to FIG. 1, in some embodiments, the data cable 100 can include a plurality of filler elements 130. Each filler element 130 can longitudinally extend between adjacent ones of the outer twisted pairs 106, 108, 110. The filler elements 130 can accordingly facilitate spacing of each of the outer twisted pairs 106, 108, 110 from the adjacent outer twisted pairs. As illustrated in FIG. 1, the filler elements 130 can have a cross-sectional shape (e.g., the cross section being taken orthogonal to the longitudinal axis) that is generally circular. It is to be appreciated that although the data cable 100 is shown as having a plurality of filler elements 130, a data cable is contemplated that includes only one filler element. It is also to be appreciated that the filler element can be formed from a solid material or a foamed material.

An alternative embodiment of a data cable 200 is illustrated in FIG. 2. The data cable 200 can be similar to, or the same as in many respects, to the data cable 100 illustrated in FIG. 1. For example, the data cable 200 can include a plurality of conductors 203 that are arranged into a central twisted pair 204 and a plurality of outer twisted pairs 206, 208, and 210. The data cable 200 can also include a plurality of separating elements 230. However, the separating elements 230 can have a polygonal cross-sectional shape that is generally T-shaped.

Another alternative embodiment of a data cable 300 is illustrated in FIG. 3. The data cable 300 can be similar to, or the same as in many respects, to the data cable 100 illustrated in FIG. 1. For example, the data cable 300 can include a plurality of conductors 303 that are arranged into a central twisted pair 304 and a plurality of outer twisted pairs 306, 308, and 310. The data cable 300 can also include a plurality of separating elements 330. However, the separating elements 330 can have a cross-sectional shape that is generally ovular shaped.

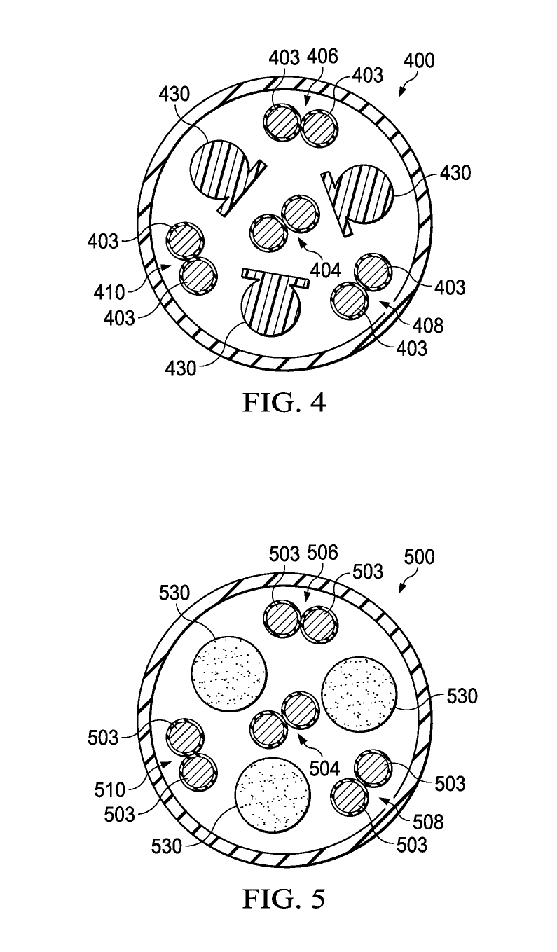

Another alternative embodiment of a data cable 400 is illustrated in FIG. 4. The data cable 400 can be similar to, or the same as in many respects, to the data cable 100 illustrated in FIG. 1. For example, the data cable 400 can include a plurality of conductors 403 that are arranged into a central twisted pair 404 and a plurality of outer twisted pairs 406, 408, and 410. The data cable 400 can also include a plurality of separating elements 430. However, the separating elements 430 can have a curvilinear cross-sectional shape that is generally circular shaped with a flat shape tangential to the circular shape.

Another alternative embodiment of a data cable 500 is illustrated in FIG. 5. The data cable 500 can be similar to, or the same as in many respects, to the data cable 100 illustrated in FIG. 1. For example, the data cable 500 can include a plurality of conductors 503 that are arranged into a central twisted pair 504 and a plurality of outer twisted pairs 506, 508, and 510. The data cable 500 can also include a plurality of separating elements 530. In this embodiment, the separating elements 530 can have a cross-sectional shape that is generally circular shaped and formed from a foamed material rather than a solid material.

The foregoing description of embodiments and examples has been presented for purposes of illustration and description. It is not intended to be exhaustive nor to be limited to the forms described. The embodiment(s) illustrated in the figures can, in some instances, be understood to be shown to scale for illustrative purposes. Numerous modifications are possible in light of the above teachings. Some of those modifications have been discussed and others will be understood by those skilled in the art. The embodiments were chosen and described in order to best illustrate various principles and how the embodiments are suited to the particular use contemplated. The scope of the present disclosure is, of course, not limited to the examples or embodiments set forth herein, but can be employed in any number of applications and equivalent devices by those of ordinary skill in the art. Rather it is hereby intended the scope of the present disclosure be defined by the claims appended hereto.

What is claimed is:

1. A data cable comprising:
a core defining a longitudinal axis and comprising:
a central twisted pair of insulated conductors disposed along the longitudinal axis, the central twisted pair having a lay length; and
a plurality of outer twisted pairs of insulated conductors, each outer twisted pair of the plurality of outer twisted pairs having a lay length; and
a jacket surrounding the core; wherein:
each outer twisted pair is positioned relative to the central twisted pair such that each outer twisted pair of the plurality of outer twisted pairs is disposed between the central twisted pair and the jacket; and
the lay length of the central twisted pair is shorter than the respective lay lengths of each outer twisted pair of the plurality of outer twisted pairs.

2. The data cable of claim 1, wherein the data cable comprises an unshielded data cable.

3. The data cable of claim 2 further comprising at least one filler element longitudinally extending between adjacent outer twisted pairs.

4. The data cable of claim 3, wherein said at least one filler element is formed of one of a solid material and a foamed material.

5. The data cable of claim 4, wherein said at least one filler element has a cross-sectional shape that is taken orthogonal to the longitudinal axis and is one of a circular shape, an ovular shape, a T-shape, and a curvilinear shape.

6. The data cable of claim 1, wherein the data cable meets the TIA 568 standard.

7. The data cable of claim 1, wherein the lay length of each outer twisted pair of the plurality of outer twisted pairs is not more than about 2.8 mm longer than the lay length of the central twisted pair.

8. The data cable of claim 1, wherein:
each conductor of the central twisted pair of insulated conductors comprises an insulating layer;
each conductor of the plurality of outer twisted pairs comprises an insulating layer;
the insulating layers of the central twisted pair are formed of a fluorinated ethylene propylene material; and
the insulating layers of the plurality of outer twisted pairs are formed entirely of a non-fluorinated ethylene propylene material.

9. The data cable of claim 1, wherein the central twisted pair of insulated conductors is insulated with a foamed material.

10. An unshielded data cable comprising:
a core defining a longitudinal axis and comprising:
a central twisted pair of insulated conductors disposed along the longitudinal axis, the central twisted pair having a central lay length;
a first outer twisted pair of insulated conductors, the first outer twisted pair having a first lay length;
a second outer twisted pair of insulated conductors, the second outer twisted pair having a second lay length; and
a third outer twisted pair of insulated conductors, the third outer twisted pair having a third lay length; and
a jacket surrounding the core; wherein:
the first, second, and third outer twisted pairs are positioned relative to the central twisted pair such that the first, second, and third outer twisted pairs are disposed between the central twisted pair and the jacket;
the central lay length of the central twisted pair is less than the first, second, and third lay lengths of the respective first, second, and third outer twisted pairs; and
the first, second, and third, lay lengths are different.

11. The unshielded data cable of claim 10 further comprising a plurality of filler elements, each filler element of the plurality of filler elements extending longitudinally between adjacent ones of the first, second, and third outer twisted pairs.

12. The unshielded data cable of claim 11, wherein each filler element of the plurality of filler elements is formed of at least one of a solid material and a foamed material.

13. The unshielded data cable of claim 12, wherein said at least one filler element has a cross-sectional shape that is taken orthogonal to the longitudinal axis and is one of a circular shape, an ovular shape, a T-shape, and a curvilinear shape.

14. The unshielded data cable of claim 10, wherein the data cable meets the TIA 568 standard.

15. The unshielded data cable of claim 10, wherein each of the first, second, and third lay lengths of the respective first, second, and third outer twisted pairs is not more than about 2.8 mm longer than the central lay length of the central twisted pair.

16. The unshielded data cable of claim 10, wherein the jacket is formed of one or more of a PVC material, a fluorinated ethylene propylene material, and a flame retardant polyolefin material.

17. A data cable comprising:
a core defining a longitudinal axis and comprising:
a central twisted pair of insulated conductors disposed along the longitudinal axis, the central twisted pair having a central lay length;
a first outer twisted pair of insulated conductors, the first outer twisted pair having a first lay length;
a second outer twisted pair of insulated conductors, the second outer twisted pair having a second lay length; and
a third outer twisted pair of insulated conductors, the third outer twisted pair having a third lay length; and
a jacket surrounding the core; wherein:
each conductor of the central twisted pair of insulated conductors comprises an insulating layer;
each conductor of the plurality of outer twisted pairs comprises an insulating layer;
the insulating layers of the conductors of the central twisted pair are formed of a fluoropolymer;
the insulating layers of the conductors of the first, second, and third outer twisted pairs are formed of a non-fluoropolymer material.

18. The data cable of claim 17, wherein:
the insulating layers of the central twisted pair are formed of a foamed material; and
the insulating layers of the conductors of the first, second, and third outer twisted pairs are formed entirely of a non-foamed material.

19. The data cable of claim 17 further comprising at least one filler element that is formed of one of a solid material and a foamed material.

20. The data cable of claim 17, wherein the insulating layers of the conductors of the first, second, and third outer twisted pairs are each formed of a polyolefin material.
